(19) United States
(12) Patent Application Publication
(10) Pub. No.: US 2007/0009656 A1
(43) Pub. Date: Jan. 11, 2007

(54) Coating method and system for forming protective layer

(76) Inventors: Bansei Nagase, Saitama-ken (JP); Akira Sakurai, Saitama-ken (JP)

Correspondence Address: FISH & RICHARDSON P.C., P.O. BOX 1022, MINNEAPOLIS, MN, 55440-1022, US

(21) Appl. No.: 10/550,832

(22) PCT Filed: Mar. 26, 2004
(86) PCT No.: PCT/JP04/04329

§ 371 Date: Sep. 23, 2005

(30) Foreign Application Priority Data
Mar. 27, 2003 (JP) 2003- 088960

(51) Int. Cl. C09D 5/00; B05D 3/02; B05D 1/02; B05C 5/00

(52) U.S. Cl. 427/154; 427/421.1; 427/372.2; 118/300

(57) ABSTRACT

A coating system for forming a protective layer includes first through fourth robots which are controlled by a controller and are provided close to a transport line, and sprayer mechanisms provided on ends of arms of the first through fourth robots. The motions of first through fourth robots are taught. Liquid material including an acrylic copolymer is sprayed onto an object such as a vehicle body, and dried to form a peelable protective layer on the object. The liquid material is sprayed from a first through fifth sprayers of the sprayer mechanism after the vehicle body is painted. At this time, the liquid material from the first sprayer is distributed locally in the smallest area. The area where liquid material is sprayed becomes wide gradually, in the order of the third sprayer, the fourth sprayer, the fifth sprayer, and the second sprayer. Such sprayers are also arranged in this order from an edge of the vehicle body.

### TECHNICAL FIELD

The present invention relates to a coating method and a coating system for applying liquid material on an object to form a protective layer on an object, and in particular relates to a coating method and a coating system which applies liquid material on painted regions of a vehicle body to form a peelable protective layer on the vehicle body after drying the liquid material.

### BACKGROUND ART

Vehicles such as automobiles are often stored outdoors in stock yards after manufacturing and are transported by trailer and ship, or the like, before being delivered to the consumer. During this long storage and transportation period, there is a possibility that, of the multiple paint layers on the exterior surface of the vehicle, the quality of the surface layer will be damaged by dust, metallic powder, salt, oils, acid, and exposure to direct sunlight, or the like.

In order to avoid degradation of the surface layer quality, a method to form a peelable protective layer on the surface layer of the painted layers prior to shipping a vehicle has been proposed in Japanese Laid-Open Patent Publication No. 2001-89697. This type of peelable protective layer is formed by applying a protective layer forming material (also known as strippable paint) which is a liquid wrap material and then drying, and the painted layers can be protected by the existence of this peelable protective layer. Note that this peelable protective layer will not naturally peel off during regular storage, but can be easily peeled off at the time of removal.

Protective layer forming material is normally applied to a vehicle body by multiple operators adhering protective layer forming material to a roller, and then rolling and moving the roller on the vehicle body. However, in this case, the operators must perform laborious operations. Furthermore, the film thickness of protective layer forming material may vary depending on the skills of operators and therefore the quality of the peelable protective layer is not consistent.

Therefore, in order to make the coating quality uniform and to reduce the burden on operators, a method where protective layer forming material is applied in a line onto a vehicle body and then the protective layer forming material is spread by air blowing, has been proposed in Japanese Laid-Open Patent Publication No. 8-173882. Using this method, many of the operations associated with the coating process are automated, the burden on operators can be reduced, and takt time can be improved.

However, using this method, there is no guarantee that the spreading of protective layer forming material are always uniform. Furthermore, this method may not be carried out suitably for the edges of the roof and hood or the like (vehicle body edges) because protective layer forming material will be scattered.

Furthermore, in recent years, the shape of vehicle bodies is becoming more complex, with recessed and raised regions and complex curves or the like. It is difficult to spread protective layer forming material in these recessed and raised regions and curves using an air nozzle. Also, it is necessary to apply a protective layer forming material relatively thick in regions where the quality is seen to be particularly critical, but when protective layer forming material is spread by an air nozzle, it is difficult to adjust the film thickness.

For these reasons, after protective layer forming material has been spread by an air nozzle, it is necessary for multiple operators to apply and finish up protective layer forming material to the roof edges and to intricate areas such as recessed and raised regions or the like. In other words, manual labor is inevitable for finishing up the application of protective layer forming material.

Therefore, it is difficult to reduce the burden on operators, and variation in coating quality based on the skill level of the operator cannot be completely avoided.

Therefore, for instance, spraying protective layer forming material from a nozzle or the like has been considered. However, if the distribution width of protective layer forming material is large when spraying (if the protective layer forming material is sprayed widely in a wide area), problems with scattering to make little islands of protective layer forming material are possible. On the other hand, if the distribution width is reduced (if the protective layer forming material is sprayed locally in a small area) in order to avoid this scattering, there will be a problem that protective layer forming material cannot efficiently be applied to the vehicle body.

Furthermore, in the factory which produces the vehicle, a plastic cover known as a scratch cover is sometimes temporarily attached to portions of a vehicle body in order to prevent scratching of the body during the assembly operation. Scratch covers, for instance, are temporarily attached to the front and side surfaces of the body and are removed prior to shipping. Scratch covers must be prepared with different configurations for each vehicle type, and multiple scratch covers must be prepared depending on the daily production volume on the transport line.

### DISCLOSURE OF INVENTION

The general purpose of the present invention is to provide a coating method and a coating system for automating the process of applying and spreading protective layer forming material on the external surface of a vehicle body, and also to simplify the operation and to make the coating quality uniform.

In one form, the present invention provides a coating method wherein protective layer forming material (liquid material) is applied to an object by a sprayer mechanism of a coating device, and the liquid material is dried to form a peelable protective layer on the object. The sprayer mechanism sprays the liquid material such that the liquid material is distributed locally at a position close to an edge of the object, and distributed widely at a position away from the edge of the object.

Using this method, by making the coating range narrower at the ends of the object to be coated, scattering of protective layer forming material to form small irregularities can positively be prevented. Therefore, protective layer forming material can be applied without variation to the edges, and therefore, a peelable protective layer with uniform quality can be formed.

A robot may be used as the coating device. In this case, a sprayer mechanism may be provided on an arm of the robot. Furthermore, an automobile body may be used as the object to be coated to which protective layer forming material is applied.

In order to apply protective layer forming material in this manner, for instance, the sprayer mechanism may have a first sprayer and a second sprayer provided in parallel on the arm. Furthermore, when the first sprayer is brought in close proximity to an end of the object to be coated, and the second sprayer is distanced from the end and protective layer forming material is sprayed from the first sprayer and the second sprayer in the direction of the object to be coated, the protective layer forming material distribution width of the first sprayer should be made narrower, and the protective layer forming material distribution width of the second sprayer should be made wider. Therefore, protective layer forming material can easily be applied without variation.

The sprayer mechanism may have at least one middle sprayer between the first sprayer and the second sprayer. Therefore, protective layer forming material can be applied over a wide range, so the coating process can be performed efficiently. Furthermore, even if protective layer forming material is scattered in a manner to make small irregularities in the center region of the object to be coated, the protective layer forming material sprayed from the adjacent sprayer will cover, so a peelable protective layer with uniform quality can be formed. Note that in this case, the protective layer forming material distribution width of the middle sprayer should be larger than the protective layer forming material distribution width of the first sprayer, and smaller than the protective layer forming material distribution width of the second sprayer.

Furthermore, the coating process can be made even more efficient by establishing two or more of the middle sprayers and applying the protective layer forming material using all of the sprayers. In this case, an interval between adjacent ones of the middle sprayers may be larger toward the second sprayer than toward the first sprayer. Therefore, for instance, overlapping of the coating region of protective layer forming material from the second sprayer, which has the largest distribution width for the sprayed protective layer forming material, and the coating region of protective layer forming material sprayed from the middle sprayer adjacent to the second sprayer can be prevented. Therefore, protective layer forming material can be applied more efficiently.

Note that for instance, the protective layer forming material distribution width can be changed by decreasing the protective layer forming material sprayed pressure of the first sprayer as compared to the second sprayer.

Furthermore, if middle sprayers exist, the protective layer forming material distribution width can be changed by making the protective layer forming material spray pressure of at least one middle sprayer to be larger than that of the first sprayer and smaller than that of the second sprayer.

Also, acrylic copolymer may be suggested as a favorable example of a protective layer forming material.

In another form, the present invention provides a coating system comprising:

a coating device disposed close to a transport line for an object to be coated,

a sprayer mechanism disposed on the coating device,

a supply mechanism which supplies liquid material to the sprayer mechanism to form a peelable protective layer on the object after drying the object, and

a controller which controls the sprayer mechanism of the coating device such that the liquid material is distributed locally at a position close to an edge of the object, and distributed widely at a position away from the edge of the object.

With this construction, the coating region of protective layer forming material can be made narrower at the ends of the object to be coated, and therefore a uniform peelable protective layer can be formed.

As described above, a robot may be suggested as an example of a coating device, and in this case, a sprayer mechanism should be mounted on an arm of the robot. Furthermore, the robot may apply the protective layer forming material to an automobile body as the object to be coated.

The sprayer mechanism preferably has a first sprayer and a second sprayer in parallel on the robot arm. Furthermore, when the first sprayer is in close proximity to the end of the object to be coated and the second sprayer is distanced from the end, the distribution widths of protective layer forming material sprayed towards the object to be coated from the first sprayer and the second sprayer should be made smaller for the first sprayer and larger for the second sprayer, by the controlling action of the controller. Therefore, the distribution width of protective layer forming material can be narrower at the end of the object to be coated and wider in the center region thereof.

The sprayer mechanism preferably also has at least one middle sprayer positioned between the first sprayer and the second sprayer. Therefore, protective layer forming material can be applied across an even wider range, so the coating process can be accomplished efficiently. Furthermore, even if protective layer forming material is scattered to create small islands in the center region of the object to be coated, protective layer forming material sprayed from an adjacent sprayer will coat over this region. Therefore, a peelable protective layer with uniform quality can be formed even in the center region of an object to be coated. Note that in this case, the distribution width of protective layer forming material by at least one of the middle sprayers should be larger than the protective layer forming material distribution width of the first sprayer and smaller than the protective layer forming material distribution width of the second sprayer.

These results are even more remarkable when the sprayer mechanism has two or more middle sprayers. In this case, if the interval between adjacent one of the middle sprayers is increased toward the second sprayer from the first sprayer, protective layer forming material will be sprayed across a wide width from the second sprayer and sprayed at a narrower width from the sprayer adjacent to the second sprayer, while ensuring that there are no regions without coating. Therefore, protective layer forming material can be efficiently applied.

Furthermore, it order to change the protective layer forming material distribution width, the controller should be set such that, for instance, the protective layer forming material spray pressure of the first sprayer is smaller than that of the second sprayer.

Also, if middle sprayers exist, the protective layer forming material distribution width can be changed by setting the protective layer forming material spray pressure of at least one of the middle sprayers to be greater than that of the first sprayer and less than that of the second sprayer.

It is preferable that the sprayer mechanism be such that protective layer forming material can be sprayed without accompanying air, or in other words to be a so-called air-less type sprayer. This type of sprayer mechanism has much better coating pattern reproducibility when applying a designated coating width and quantity of protective layer forming material as compared to standard sprayer mechanisms which spray protective layer forming material along with air. In other words, the desired coating pattern will be easy to achieve.

In either case, acrylic type copolymer is preferred as the protective layer forming material.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF DRAWINGS

FIG. 1 is a perspective view of the whole outline of a coating system for forming a protective layer according to an embodiment of the present invention.

FIG. 2 is a front elevational view of FIG. 1.

FIG. 3 is a perspective view of a robot and a sprayer mechanism attached to the robot in the coating system.

FIG. 4 is an expanded side elevational view of main components of the sprayer mechanism.

FIG. 5 is a circuit diagram showing complex hydraulic and pneumatic circuits of the coating system.

### BEST MODE FOR CARRYING OUT THE INVENTION

A coating method and a system of carrying out the method according to an embodiment of the present invention will be described with reference to the attached drawings.

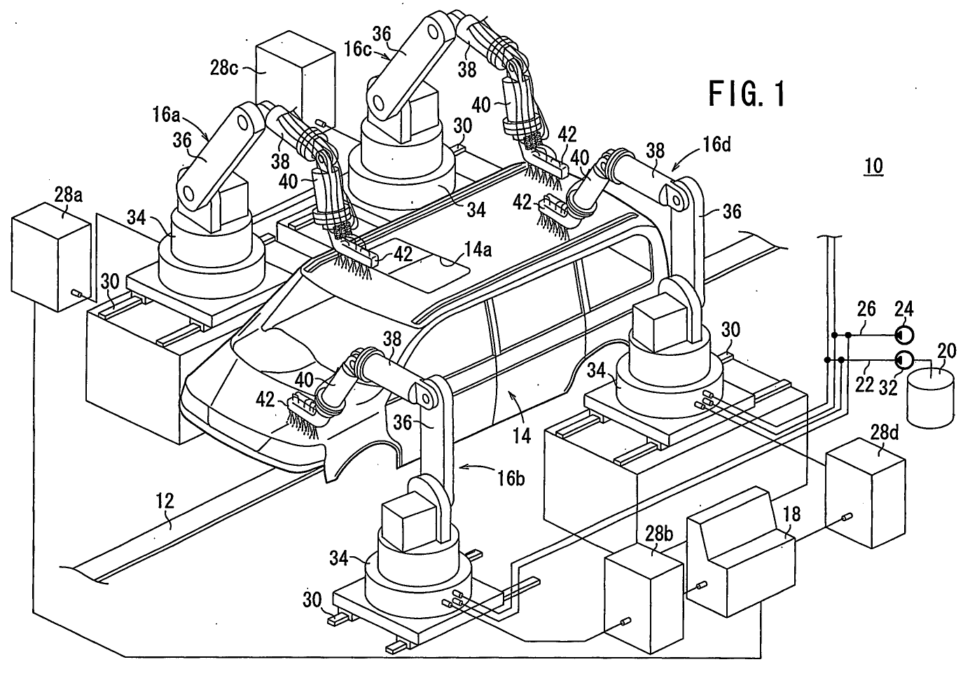

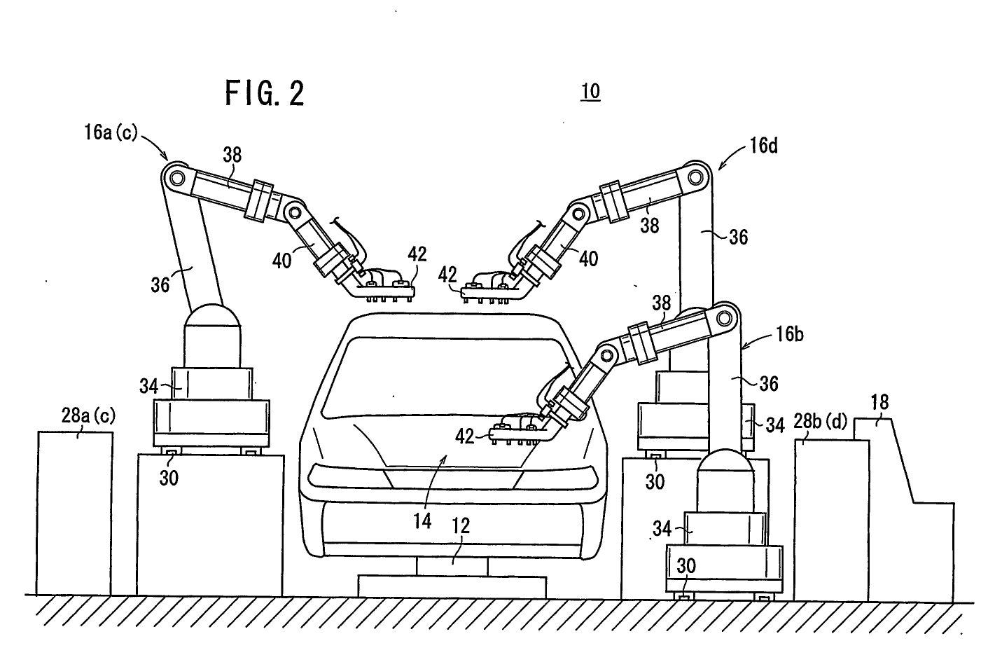

A summary perspective view of the protective layer forming material coating system of the present embodiment (hereafter also referred to as the coating system) is shown in FIG. 1, and a front elevational view thereof is shown in FIG. 2. As shown in FIG. 1 and FIG. 2, the coating system 10 is provided on a vehicle transport line 12, and applies protective layer forming material (liquid material) to a vehicle body 14 which has completed the painting process.

The coating system 10 includes, for example, four industrial robots namely, first through fourth robots 16a-16d, a controller 18 which controls the entire system, a tank 20 which stores protective layer forming material, a tube 22 which connects from the tank 20 to the first through fourth robots 16a-16d, and a water tube 26 which supplies water from a water supply source 24 to the first through fourth robots 16a-16d. The first through fourth robots 16a-16d are respectively controlled by robot controllers 28a-28d which are connected to the controller 18.

The first robot 16a and the third robot 16c are provided on the left-hand side in the direction of progression of the vehicle body 14 on the transport line 12, and the second robot 16b and the fourth robot 16d are provided on the right-hand side in the direction of progression. Furthermore, the first robot 16a and the second robot 16b are provided at the front in the direction of progression, and the third robot 16c and the fourth robot 16d are provided at the back in the direction of progression. The first through fourth robots 16a-16d are movable along slide rails 30 which are extending in parallel to the transport line 12.

A pump 32 is provided in the middle of the tube 22, and the pump 32 draws up protective layer forming material from the tank 20 and supplies the material to the first through fourth robots 16a-16d. Furthermore, the tank 20 and the tube 22 are temperature controlled by a heater and thermostat not shown in the drawings in order to maintain the protective layer forming material at an appropriate temperature.

The main component of the protective layer forming material may be acrylic copolymer, and it is desirable to use two types of acrylic copolymer with different glass transition temperatures. Specifically, the protective layer forming material may be, for instance, that shown in Japanese Laid-Open Patent Publication No. 2001-89697. Furthermore, the protective layer forming material can have its viscosity adjusted by changing the temperature and ratio of water, and when the material is dried, the material adheres to the vehicle body 14 and can chemically and physically protect the painted region of the vehicle body 14 from dust, metallic powder, salt, oils, acid, and direct sunlight. Furthermore, the layer will easily peel off the vehicle body 14, for example, when delivered to the user.

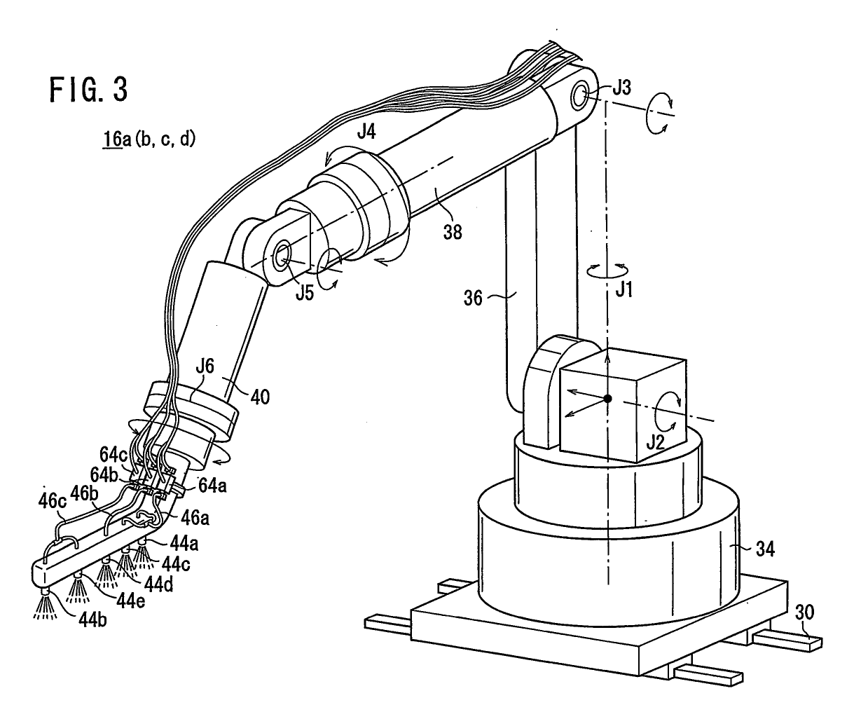

As shown in FIG. 3, the first robot 16a is a multi-jointed industrial robot, and includes a base 34, and in order from the base 34, a first arm 36, a second arm 38, and a third arm 40, and a sprayer mechanism 42, which will be described later, is provided on the tip end of the third arm 40.

The first arm 36 is able to rotate because of rotating shafts J1, J2 which are rotatable in parallel and perpendicular to the base 34. Furthermore, the second arm 38 can rotate relative to the first arm 36 through a shaft J3, and the end is able to twist because of a shaft J4. Furthermore, the third arm 40 is connected in a manner which can rotate relative to the second arm 38 because of a shaft J5, and the end is able to twist because of a shaft J6.

The remaining second through fourth robots 16b-16d have a similar construction to the first robot 16a, and therefore identical components are assigned identical reference flags and the detailed descriptions are omitted. Note that the first through fourth robots 16a-16d may also have components which extend and retract or move link in parallel, in addition to rotation.

Furthermore, the tip ends of the third arms 40 of the first through fourth robots 16a-16d each has a sprayer mechanism 42 which is supplied protective layer forming material by the tube 22. These sprayer mechanisms 42 are able to move to any arbitrary position in close proximity to the vehicle body 14 and be set to any arbitrary direction by the movement of the six shaft construction of the first through fourth robots 16a-16d described above. In other words, the sprayer mechanism 42 can move with six degrees of freedom.

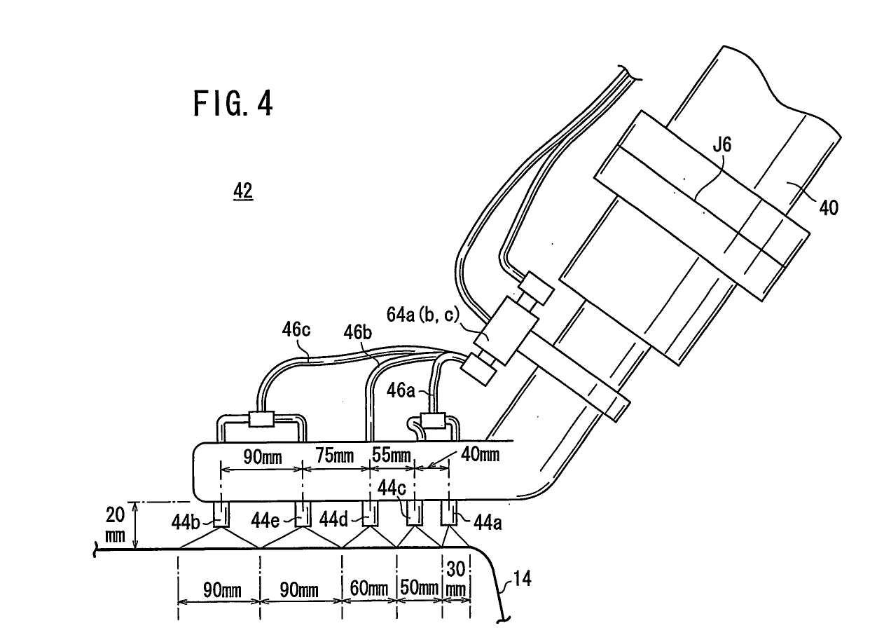

As shown in FIG. 4, in this case, the sprayer mechanism 42 has a sprayer comprising a first gun chip 44a closest to the third arm 40, a second gun chip 44b furthest from the third arm 40, and third through fifth gun chips 44c-44e which are between the first gun chip 44a and the second gun chip 44b.

The interval between the first gun chip 44a and the third gun chip 44c, the interval between the third gun chip 44c and the fourth gun chip 44d, the interval between the fourth gun chip 44d and the fifth gun chip 44e, and the interval between the fifth gun chip 44e and the second gun chip 44b are 40 mm, 55 mm, 75 mm, and 90 mm respectively. In other words, the intervals between adjacent gun chips increase from the first gun chip 44a to the second gun chip 44b.

As shown in FIG. 3, the tube 22 may be divided into three branches, namely the first through the third branch pipes 46a-46c, and the first branch pipe 46a is further branched into two, which connect a passage (not shown in the drawings) through to the first gun chip 44a and the third gun chip 44c. Furthermore, the second branch pipe 46b communicates with the fourth gun chip 44d, and similar to the first branch pipe 46a, the third branch pipe 46c is further branched into two, which connects the fifth gun chip 44e and the second gun chip 44b.

Each of the gun chips 44a-44e is connected to a supply mechanism in order to spray protective layer forming material or water. In other words, a hydraulic and pneumatic complex circuit 50 which supplies protective layer forming material to the first gun chip 44a and the third gun chip 44c, for instance, includes an compressor 52, an air tank 54 which is connected to the discharge port of the compressor 52, a pneumatic manual on-off valve 56 which switches between supplying or cutting off pneumatic pressure, a regulator 58 which reduces a secondary side pressure based on an electric signal supplied from the controller 18, and a regulator operating valve 60 which reduces the pressure in the first branch pipe 46a which is pilot controlled by the secondary pressure of the regulator 58.

As can be clearly understood from the above, each of the gun chips 44a-44e which make up the sprayer mechanism 42 are able to spray protective layer forming material without accompanying air. In other words, the gun chips 44a-44e are so-called airless nozzles.

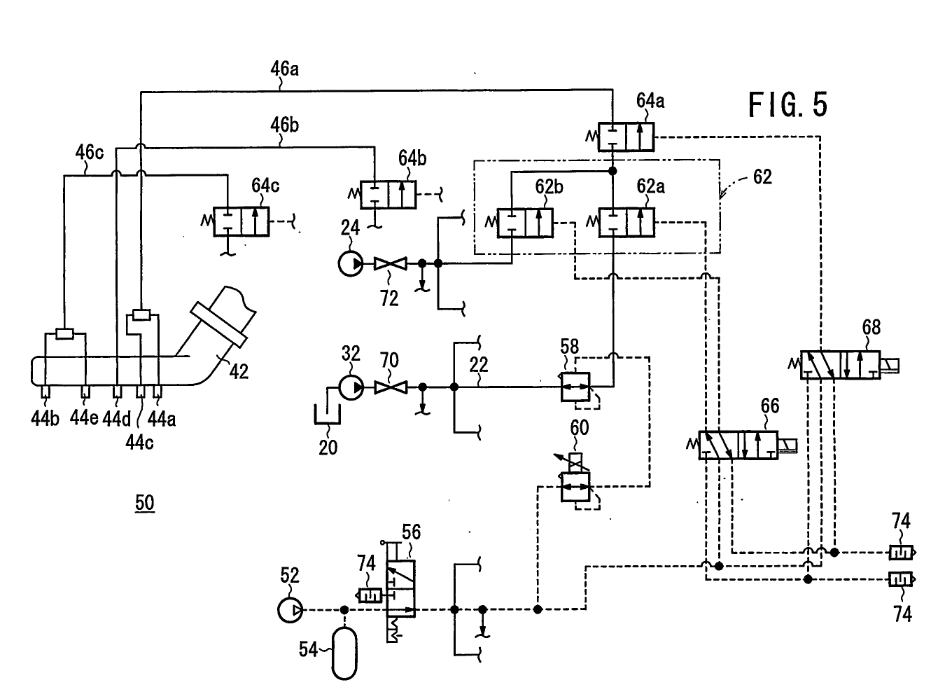

Furthermore, the complex circuit 50 also contains a material control valve (MCV) 62 which is connected to the secondary side of the regulator operating valve 60 and the water tube 26, and a trigger valve 64 which is provided between the secondary side of the MCV 62 and a roller 48. Switching valves 62a, 62b are provided inside the MCV 62 and, switch between connecting and cutting off of the tube 22 and the water tube 26. The secondary sides of the switching valves 62a, 62b are connected. The broken lines in FIG. 5 show a pneumatic tube.

The complex circuit 50 also includes an MCV switching electromagnetic valve 66 which operates the switching valves 62a, 62b as a pilot system, and a trigger switching electromagnetic valve 68 which pilot operates a trigger valve 64a. The MCV switching electromagnetic valve 66 opens one of the switching valves 62a, 62b depending on an electric signal supplied from the controller 18 and closes the other, thus switching between providing water and protective layer forming material to the trigger valve 64a. The trigger switching electromagnetic valve 68 switches between connecting and cutting off the trigger valve 64a based on an electric signal provided from the controller 18, and provides either the protective layer forming material or water to the sprayer mechanism 42. Note that the MCV 62, the trigger valve 64a, and the regulator operating valve 60 are not restricted to pneumatic pilot type valves, but other types such as electric solenoid valves are also applicable.

Manual cutoff valves 70, 72 are provided along the tube 22 and the water tube 26, respectively. Normally, the cutoff valves 70, 72 are left open. Silencers 74 are provided on all of the air exhaust ports in the complex circuit 50 in order to reduce the exhaust noise. The compressor 52, the pump 32, and the water supply source 24 have relief valves (not shown in drawings) in order to prevent excessive pressure rise.

The above configuration is also applied in the second branch pipe 46b and the third branch pipe 46c, and therefore, devices other than trigger valve 64b, 64c are not shown in the drawings and the detailed description is omitted.

The compressor 52, the air tank 54, the water supply source 24, and the pump 32 in the complex circuit 50 are. common for the first through fourth robots 16a-16d, but all the other devices are provided for each of the first through fourth robots 16a-16d.

Next, the method of applying protective layer forming material to the vehicle body 14 using the coating system 10 will be described.

First, the motion of each of the first through fourth robots 16a-16d is taught beforehand. For example, the first through fourth robots 16a-16d are assigned to the right front roof, left front hood, right back roof, and left back roof of the vehicle body 14 which is a station wagon, respectively. The motion of each of the first through fourth robots 16a-16d is taught so that the sprayer mechanism 42 moves along a designated path in each of the assigned regions, and the teaching data is recorded and stored in the designated recording device of the controller 18. The sprayer mechanism 42 is able to move with six degrees of freedom by the mechanism of the first through fourth robots 16a-16d, so that the sprayer mechanism 42 can be applied to any complicated shapes of an object.

The transport line 12 is often used for various vehicle types, and even in the same type, the vehicle body 14 may have different detailed configurations such as a body with or without a sunroof opening 14a (Refer to FIG. 1), bulged regions, or a rear spoiler. For differences in the vehicle type and detailed configurations, the motion of each of the first through fourth robots 16a-16d should be taught in view of each individual vehicle type and each detailed configuration. The controller 18 receives a signal identifying the vehicle type and detailed configuration from the transport line 12, and based on this signal, selects the teaching data and drives the first through fourth robots 16a-16d.

The preferred distance between the vehicle body 14 and the sprayer mechanism 42 is approximately 20 mm. The vehicle body 14 does not have to be a finished vehicle on which all the necessary components are mounted, as long as the painting process of the vehicle is completed.

By the motion teaching, the process of applying protective layer forming material should be completed within the takt time for each vehicle body 14 on the transport line 12.

On the other hand, the temperature of the tank 20 (refer to FIG. 4) and the tube 22 is adjusted to the predetermined appropriate temperature by a heater. Also, the operating compressor 52, the water supply source 24, and the pump 32 are operated, and the first through fourth robots 16a-16d are put in standby in a position which will not interfere with the vehicle body 14, and the pneumatic on-off valve 56 is opened.

Next, the vehicle body 14 whose painting is completed is conveyed by the transport line 12, and is stopped at a position close to the first through fourth robots 16a-16d. The controller 18 recognizes that the vehicle body 14 is conveyed either by a signal supplied from the transport line 12 or by a sensor (not shown in the drawings), and drives the first through fourth robots 16a-16d based on the teaching data.

At this time, the controller 18 sets the spray pressure of the protective layer forming material passing through the first branch pipe 46a, the second branch pipe 46b, and the third branch pipe 46c to be (for example) 0.05 MPa, 0.2 MPa, and 0.5 MPa, respectively, by the regulator operating valve 60 with the regulator 58 (Refer to FIG. 5). By setting the spray pressure using each regulator, the distribution width with which the protective layer forming material is sprayed can be controlled as described later.

On the other hand, the controller 18 controls the MCV 62 through the MCV switching electromagnetic valve 66, and connects the tube 22 while cutting off the water tube 26. Furthermore, the controller 18 connects the trigger valve 64a-64c by operating the trigger switching electromagnetic valve 68.

By the control of the controller 18, the protective layer forming material maintained at an appropriate temperature is sprayed toward the vehicle body 14 from the first gun chip 44a, the third through fifth gun chips 44c-44e, and the second gun chip 44b. In other words, the application of the protective layer forming material to the vehicle body 14 begins.

At this time, as described above, the protective layer forming material is sprayed at a spray pressure of 0.05 MPa from the first gun chip 44a and the third gun chip 44c which are connected to the first branch pipe 46a. The protective layer forming material sprayed from the first gun chip 44a and the third gun chip 44c adheres to vehicle body 14 when the distribution width is 30 mm and 50 mm, respectively (Refer to FIG. 4).

Similarly, the protective layer forming material is sprayed at 0.2 MPa from the fourth gun chip 44d, and at 0.5 MPa from the fifth gun chip 44e and the second gun chip 44b, and the protective layer forming material adheres to the vehicle body 14 when the distribution widths become 60 mm, 90 mm, and 90 mm, respectively.

With the present preferred embodiment, the distribution width of the protective layer forming material can be small on the edge of vehicle body 14, and large in the center region by adjusting the spray pressure. In this way, the protective layer forming material can be applied to a wide region, and the efficiency in applying the protective layer forming material can be improved.

Also, in this case, the coating range is narrow at the edge of the vehicle body 14, so that some irregularities on the surface by scattering the protective layer forming material can be significantly reduced. Even if the protective layer forming material sprayed from the second gun chip 44b is scattered and some irregularities are formed on the region of the vehicle body 14 to which the protective layer forming material is applied by the fifth gun chip 44e, the protective layer forming material sprayed from the fifth gun chip 44e will also be applied in this region. Therefore, an even peelable protective layer will finally be formed.

With this present embodiment, the protective layer forming material can be efficiently applied to a wide region, and scattering of protective layer forming material at the edges of the vehicle body 14 can be reduced. Also, in the center region, coating unevenness can be eliminated because even if the scattering occurs, another protective layer forming material will be applied. As a result, an even peelable protective layer can be formed.

Therefore, there is no need for operators to finish the coating process by manual operation. In other words, with this embodiment, the process of applying protective layer forming material can be automated and the coating quality is consistent. Furthermore, because the process of operators applying protective layer forming material is eliminated by automation, the number of processes are reduced and production efficiency can be increased. Furthermore, air conditioning equipment for operators can be eliminated. Therefore, energy can be conserved because of the reduced electrical power required for air conditioning, and the operating costs of the factory will be reduced while becoming more environmentally friendly.

When the coating is performed, the first through fourth robots 16a-16d move at a designated speed along the slide rails 30. Furthermore, after protective layer forming material has been applied, the vehicle body 14 is transported to the next process along the transport line 12. During this time, the first through fourth robots 16a-16d move back to positions which will not interfere with the vehicle body 14, and wait in standby until the next vehicle body 14 is introduced. During this time, the controller 18 stops the supply of protective layer forming material by shutting off the trigger valves 64a-64c.

The protective layer forming material which has been applied is naturally dried or dried by forced air, for example, to form a peelable protective layer, and protects the painted regions of the vehicle body 14.

The peelable protective layer formed from protective layer forming material can protect the painted regions of the vehicle body 14 after shipping, and can also act as a scratch cover and protect the painted regions in the factory as well. Therefore, there is no need to prepare multiple scratch covers with different configurations for each vehicle type, as has conventionally been required.

When operations are over or during maintenance, the MCV 62 is made to function by the MCV switching electromagnetic valve 66, shutting off the switching valve 62a, while the switching valve 62b is opened. In addition, water is supplied from the water tube 26, so that the MCV 62, the trigger valves 64a-64c, and all the gun chips 44a-44e can be washed.

In the present embodiment, protective layer forming material is sprayed from all of the five gun chips 44a-44e, but when protective layer forming material is applied to narrow regions such as the edges around the hood or the like, the trigger valve 64b and the trigger valve 64c may be closed off, for instance, so that protective layer forming material is sprayed from only two gun chips, namely the first gun chip 44a and the third gun chip 44c. At this time, the protective layer forming material spray pressure should be set to make a distribution width which does not cause scattering of protective layer forming material.

Furthermore, if there are regions which are not coated by the coating system 10, another coating system 10 may be provided in order to coat these uncoated areas.

Furthermore, for regions with complex configurations or intricate regions on the vehicle body 14, or areas which are difficult or impossible to apply protective layer forming material by the first through fourth robots 16a-16d, it is still possible for operators to finish the coating. In this case, fewer areas remain to apply protective layer forming material, so the burden on operators can be dramatically reduced.

The bumpers of the vehicle body 14 are sometimes colored and do not require painting, but protective layer forming material may also be applied to regions other than painted regions, such as bumpers.

The coating method and system of the present invention may of course have various constructions without deviating from the substance, spirit or essence of the present invention. For instance, having more or less than five gun chips is also acceptable, and by increasing or decreasing the aperture of the gun chips, the distribution width of protective layer forming material may also be adjusted. For example, the distribution width of protective layer forming material sprayed from the second gun chip 44b, the fifth gun chip 44e, and fourth gun chip 44d may be in the range of 50-90 mm, 50-90 mm, and 50-60 mm, respectively.

The distribution width of protective layer forming material can also be adjusted by adjusting the distance between the vehicle body 14 and the sprayer mechanism 42, or by adjusting the spray pressure of each gun chip 44a-44e.

### INDUSTRIAL APPLICABILITY

The present invention, for instance, may be used in the process of applying protective layer forming material to various types of objects to be coated such as automobile bodies. In this case, the process of applying protective layer forming material is automated and therefore a peelable protective layer with nearly consistent quality can be formed.

By using an acrylic copolymer as the base material for the protective layer forming material, the object to be coated can be even more positively protected, and a peelable protective layer which can be easily removed can be formed.

1. A method of forming a protective layer, comprising the steps of:
applying liquid material to an object from a sprayer mechanism of a coating device; and
drying said liquid material to form a peelable protective layer,
wherein said sprayer mechanism sprays said liquid material such that said liquid material is distributed locally at a position close to an edge of said object, and distributed widely at a position away from said edge of said object.

2. A coating method according to claim 1, wherein
said coating device is a robot, said sprayer mechanism is attached to an arm of said robot, and said object is a vehicle body.

3. A coating method according to claim 1, wherein
said sprayer mechanism comprises a plurality of sprayer mechanisms, and said coating device comprises a plurality of coating devices corresponding to said sprayer mechanisms, said coating devices are robots, said sprayer mechanisms are attached to corresponding arms of said robots, and said object is a vehicle body.

4. A coating method according to claim 1, wherein
said sprayer mechanism comprises a first sprayer and a second sprayer which are placed in parallel on an arm of said coating device, said method comprising the step of moving said first sprayer close to said edge and moving said second sprayer away from said edge, and
when said liquid material is sprayed from said first sprayer and said second sprayer towards said object, said liquid material is distributed locally from said first sprayer, and said liquid material is distributed widely from said second sprayer.

5. A coating method according to claim 4, wherein
said sprayer mechanism further comprises at least one middle sprayer, between said first sprayer and said second sprayer, and
said liquid material from said middle sprayer is distributed widely in comparison with said liquid material from said first sprayer, and distributed locally in comparison with said liquid material from said second sprayer.

6. A coating method according to claim 5, wherein
intervals between adjacent ones of said first sprayer, middle sprayer and said second sprayer are large at positions close to said second sprayer and small at positions close to said first sprayer.

7. A coating method according to claim 4, wherein
spray pressure of said liquid material from said first sprayer is smaller than that of said second sprayer.

8. A coating method according to claim 5, wherein
spray pressure of said liquid material from said at least one middle sprayer is larger than that of said first sprayer and smaller than that of said second sprayer.

9. A coating method according to claim 5, wherein
said sprayer mechanism comprises multiple middle sprayers between said first sprayer and said second sprayer, and
spray pressure of said liquid material from at least one of said middle sprayers is larger than that of said first sprayer and smaller than that of said second sprayer.

10. A coating method according to claim 1, wherein said liquid material comprises acrylic copolymer as a main component.

11. A coating system comprising:
a coating device provided close to a transport line for an object to be coated,
a sprayer mechanism provided on said coating device,
a supply mechanism which supplies liquid material to said sprayer mechanism to form a peelable protective layer on said object after drying said object, and
a controller which controls said sprayer mechanism of said coating device such that said liquid material is distributed locally at a position close to an edge of said object, and distributed widely at a position away from said edge of said object.

12. A coating system according to claim 11, wherein
said coating device is a robot and said sprayer mechanism is mounted on an arm of said robot, and applies said liquid material to a vehicle body as said object.

13. A coating system as in claim 11, wherein
said sprayer mechanism comprises a plurality of sprayer mechanisms, and said coating device comprises a plurality of coating devices corresponding to said sprayer mechanisms, said coating devices are robots, said sprayer mechanisms are attached to corresponding arms of said robots, and said object is a vehicle body.

14. A coating system according to claim 11 wherein
said sprayer mechanism comprises a first sprayer and a second sprayer which are positioned in parallel on an arm, and
when said first sprayer is close to said edge, while said second sprayer is away from said edge, said controller controls said sprayer mechanism such that said liquid material is distributed locally from said first sprayer, and said liquid material is distributed widely from said second sprayer.

15. A coating system according to claim 14, wherein
said sprayer mechanism further comprises at least one middle sprayer positioned between said first sprayer and said second sprayer, and
said controller controls said sprayer mechanism such that said liquid material from said middle sprayer is distributed widely in comparison with said liquid material from said first sprayer, and distributed locally in comparison with said liquid material from said second sprayer.

16. A coating system according to claim 15, wherein
said sprayer mechanism further comprises multiple middle sprayers, and
intervals between adjacent ones of said middle sprayers are large at positions close to said second sprayer, intervals between adjacent ones of said middle sprayers are small at positions close to said first sprayer.

17. A coating system according to claim 11, wherein
said controller controls said sprayer mechanism such that spray pressure of said liquid material from said first sprayer is smaller than that of said second sprayer.

18. A coating system according to claim 15, wherein
spray pressure of said liquid material from said at least one middle sprayer is larger than that of said first sprayer and smaller than that of said second sprayer.

19. A coating system according to claim 15, wherein
said sprayer mechanism comprises multiple middle sprayers between said first sprayer and said second sprayer, and
spray pressure of said liquid material from at least one of said middle sprayers is larger than that of said first sprayer and smaller than that of said second sprayer.

20. A coating system according to claim 11, wherein
said sprayer mechanism sprays said liquid material without accompanying air.
